(19) United States
(12) Patent Application Publication
(10) Pub. No.: US 2026/0009468 A1
(43) Pub. Date: Jan. 8, 2026

(54) ACTUATOR FOR A PARKING LOCK SYSTEM OF A VEHICLE GEARBOX

(71) Applicant: VALEO ELECTRIFICATION, Cergy Pontoise (FR)

(72) Inventors: Pierre COLOMB, Cergy Pontoise (FR); Sylvain GAUTIER, Cergy Pontoise (FR); Laurent CHIRON, Cergy Pontoise (FR); Mickael BESNARD, Cergy Pontoise (FR)

(73) Assignee: VALEO ELECTRIFICATION, Cergy Pontoise (FR)

(21) Appl. No.: 18/879,978

(22) PCT Filed: Jul. 25, 2023
(86) PCT No.: PCT/EP2023/070591

§ 371 Date: Dec. 30, 2024

(30) Foreign Application Priority Data
Aug. 3, 2022 (FR) FR2208059

(51) Int. Cl. F16H 63/34; F16H 19/08

(52) U.S. Cl. CPC F16H 63/3466; F16H 19/08

(57) ABSTRACT

An actuator for a parking lock system of a vehicle gearbox includes an intermediate support member to which an electric motor and a gear power transmission system kinematically connected to the electric motor are attached. The actuator further includes a torque output element that meshes with the gear power transmission system and is rotatably movable between a locking position and an unlocking position, and the intermediate support member and the torque output element are provided in a housing. The torque output element is rotatably guided by the housing.

The invention relates to an actuator for a parking lock system of a vehicle gearbox, in particular a motor vehicle equipped with an automatic gearbox, for example a hybrid vehicle. The invention also applies to a parking lock system of a reducer associated with an electric vehicle motor. The gearbox or the reducer will more generally be referred to as transmission gearbox. This locking system is better known as a park-lock or parking lock.

Such an actuator allows the transmission gearbox to be immobilized when parked, by means of a lever engaging with a toothset of the transmission gearbox.

Actuators of this type are known and are conventionally designed with a worm and wheel gearing system for transmitting the rotational movement of an electric motor to a torque output element of the actuator.

Document US 2019136974 A1 has the disadvantage of not using the one same frame of reference for the electric motor 20 and for the toothed wheel 31 because the motor is supported by the housing 10 of the actuator and the toothed wheel is guided in rotation by the intermediate plate 50. This change in the frame of reference may lead to premature wearing of the worm and wheel gearing system.

Document DE 102019100300 A1 has the disadvantage that the housing is not taken into consideration when calculating the tolerances and this may lead to faulty positioning of the gearbox with respect to the torque output element 2 when it is mounted on the transmission gearbox.

In order to minimize the wearing of a worm and wheel gearing system, it is necessary to have high precision of the center-to-center distance between the worm and the wheel. For that, it is necessary to position the electric motor and its worm very precisely with respect to the toothed wheel. It is also necessary for the electric motor to be positioned and held in place very precisely in the axial direction, namely along an axis passing through its output shaft.

Another related constraint dictates good precision between the torque output element and the transmission gearbox on which the actuator is mounted in order to conform to the tolerances demanded by the transmission gearbox manufacturer. To achieve that, it is necessary for the torque output element to be positioned very precisely with respect to the housing of the actuator which is itself mounted on the transmission gearbox.

In summary, it is necessary for the worm and wheel to have the one same frame of reference and for the torque output element and the housing likewise to have the one same frame of reference.

Thus, the invention proposes an actuator for a parking lock system of a vehicle transmission gearbox, said actuator comprising an intermediate support member to which an electric motor and a geared power transmission system kinematically connected to the electric motor are attached, said actuator further comprising a torque output element that meshes with the geared power transmission system and is movable in rotation between a locking position and an unlocking position, the intermediate support member and the torque output element being housed in a housing and the torque output element being guided in rotation by the housing.

This arrangement thus allows the electric motor and the geared power transmission system to have the one same frame of reference, namely the intermediate support member, just as the torque output element and the housing have the same frame of reference, namely the housing.

The electric motor is thus self-supported by the intermediate support member. In other words, the electric motor is supported exclusively by the intermediate support member.

What is meant by an intermediate support member is an element of the actuator that is distinct from the housing and from the cover, this support member being termed intermediate because it is interposed between the housing and the cover.

The torque output element may be guided in rotation directly by the housing or indirectly by means of bearings.

Another advantage of this architecture is simplified assembly. Specifically, the intermediate support member, the electric motor and the geared power transmission system form a subassembly that can easily be integrated into the housing, thereby avoiding the handling of components on an assembly line.

According to the invention, the geared power transmission system is a worm and wheel system. The worm is on an output shaft of the electric motor. The toothed wheel system may be a single-stage or a double-stage system.

According to one feature of the invention, the end of the output shaft of the electric motor is guided in rotation by the intermediate support member. In other words, the intermediate support member forms a guide bearing to guide the end of the output shaft of the electric motor. The intermediate support member thus prevents the motor output shaft from bending as a result of the forces associated with the geared power transmission system.

Advantageously, the electric motor comprises a front face and a rear face, said front face being mounted in an opening of the intermediate support member and the rear face being held on the intermediate support member by a compression plate attached to the intermediate support member. Advantageously, the compression plate is made of metal. The compression plate is preferably U-shaped. This compression plate allows the electric motor to be held axially against the intermediate support member. This compression plate also makes it possible to absorb the significant shocks and loadings originating from the locking system, notably through ratcheting effects.

According to the invention, the electric motor is immobilized against rotating with respect to the intermediate support member by means of a lug extending out of the intermediate support member and collaborating with a cutout of the electric motor.

According to an additional feature of the invention, the toothed wheel system is mounted with the ability to rotate on a shaft, said shaft being mounted on the one hand in the intermediate support member and, on the other hand, in the housing.

According to the invention, the torque output element comprises a toothed sector that meshes with the geared power transmission system.

According to the invention, the toothed wheel system is a two-stage system, the first stage of the toothed wheel meshing with the worm of the output shaft of the electric motor and the second stage of the toothed wheel meshing with the toothed sector of the torque output element.

According to the invention, the intermediate support member has a first face, on which the geared power transmission system is mounted, facing the housing, and a second face facing an electronic board.

According to another feature of the invention, the torque output element passes through the intermediate support member and, at its opposite end from the torque output, has a magnetic target facing a sensor mounted on the electronic board. More specifically, the intermediate support member has an opening through which the torque output element may pass, from its first face to its second face. The intermediate support member does not contribute to guiding the rotation of the torque output element; there is a radial clearance between the intermediate support member and the torque output element.

Further features and advantages of the invention will become apparent from the following study of a detailed exemplary embodiment, with reference to the attached figures:

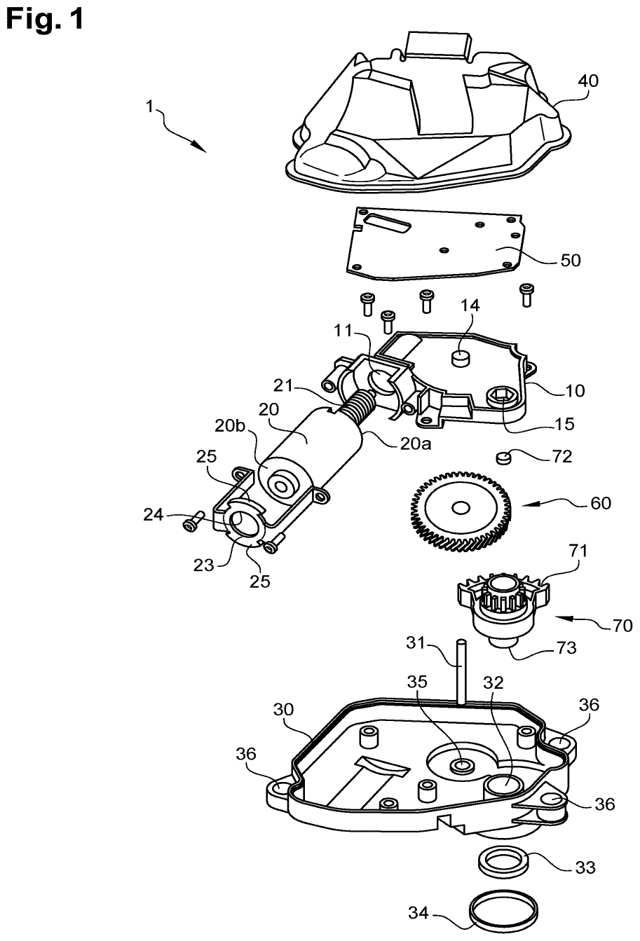

FIG. 1 depicts an exploded perspective view of the actuator according to the invention;

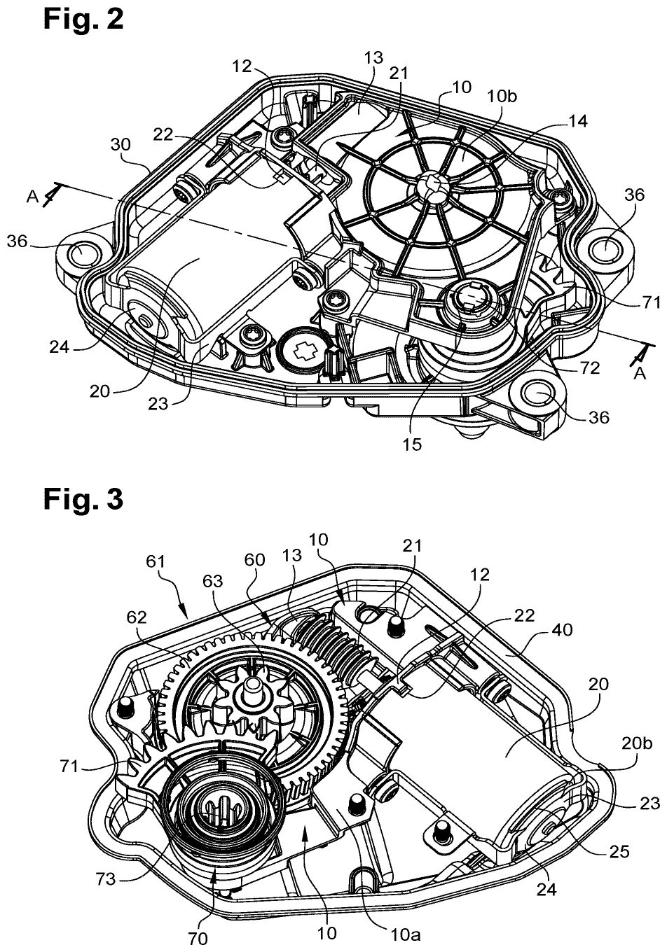

FIG. 2 depicts a perspective view, from above, of the actuator of FIG. 1, without the cover;

FIG. 3 depicts a perspective view, from beneath, of the actuator of FIG. 1, without the housing;

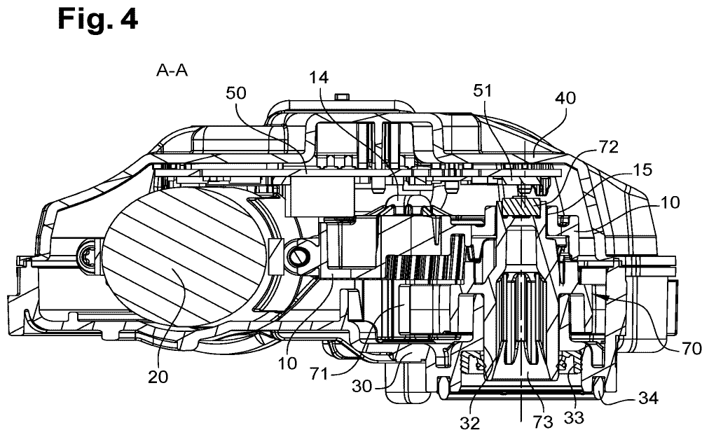

FIG. 4 depicts a view in section on A-A of the actuator of FIG. 2.

It should be noted that the figures disclose the invention in a sufficiently detailed manner for the implementation thereof, said figures helping to better define the invention as required. However, the invention should not be limited to the embodiment disclosed in the description.

With reference to FIG. 1 to FIG. 4, the actuator 1 chiefly comprises a housing 30, an electric drive motor 20, a geared power transmission system 60, an intermediate support member 10, a torque output element 70, an electronic board 50 and a cover 40. The geared power transmission system 60 reduces the speed and increases the torque of the electric motor 20. There may potentially be a gearset kinematically between the electric motor 20 and the torque output element 70. The housing 30 and the cover 40 once assembled with one another form an internal volume in which the electric motor 20, the geared power transmission system 60, the intermediate support member 10, the torque output element 70 and the electronic board 50 are housed. The housing 30 and the cover 40 may be assembled with one another using any type of fluidtight fixing, for example screw-fastening, adhesive bonding, or laser or ultrasonic welding. The housing 30 and the cover 40 are made of plastic, notably glass fiber reinforced PBT. A semipermeable membrane, which is to say one that is permeable to gases and impermeable to liquids, is housed in the housing 30 or in element 40 in order to automatically regulate the pressure inside the actuator 1.

The housing is able to be attached to a transmission gearbox via means of attachment that pass through openings 36 of the housing. The housing 30 is thus positioned precisely in relation to the transmission gearbox.

The torque output element 70 is produced in the form of a shaft of which one end takes the form of a star-shaped female connector 73 into which an actuating rod (not depicted) of a locking system is able to engage so as to lock or unlock a toothset of the transmission gearbox (not depicted) via an actuating lever or latch (not depicted). Alternatively, the torque output element 70 may be produced in the form of a male connector. The torque output element 70 comprises a toothed sector 71 that meshes with the geared power transmission system 60.

The housing 30 comprises an opening 32 in the form of a guide barrel into which the torque output element 70 is mounted. Because of the precise tolerancing between the opening 32 and the torque output element 70, precise rotational guidance allows the torque output element 70 to move between a locking position and an unlocking position. A sealing means 33, for example in this instance a lip seal, is positioned concentrically with the opening 32, to ensure that external contaminants do not enter the actuator 1. Similarly, there is a sealing means 34, for example in this instance an O-ring, provided between the housing 30 and the transmission gearbox.

The intermediate support member 10 supports the electric motor 20 and the geared power transmission system 60 to ensure precise tolerances on the mutual assembly of these two elements. The intermediate support member 10 thus guides the rotation of the geared power transmission system 60. The geared power transmission system 60 is kinematically connected to the electric motor 20 and to the torque output element 70. The intermediate support member 10, the electric motor 20 and the geared power transmission system 60 form a subassembly that can easily be integrated into the housing 30.

The geared power transmission system 60 is a worm 21 and wheel 61 system. The worm 21 is on an output shaft of the electric motor 20. The end of the output shaft of the electric motor 20 is rotationally guided by a bearing 13 formed as an integral part of the intermediate support member 10.

The electric motor 20 comprises a front face 20a and a rear face 20b. The front face 20a and the rear face each comprise a protrusion corresponding to a shape that complements that of a rolling bearing internal to the electric motor. The front face 20a is mounted in an opening 11 of the intermediate support member 10, and the rear face 20b is held on the intermediate support member 10 by a compression plate 23 attached to the intermediate support member 10. The compression plate 23 is a metal strip with elastic properties. The rear face 20b of the electric motor is housed in an opening 24 in the compression plate 23 by having mutually complementing shapes. The compression plate 23 is attached to the intermediate support member 10 by means of attachment, notably two screws, situated one on each side of the front face 20a of the electric motor 20. The compression plate 23 may optionally be fixed to the housing 30 by a tab and a means of attachment, notably a screw, situated near the rear face 20b of the electric motor. The compression plate also comprises two wings 25 pressing against the rear face 20b of the electric motor 20. These two wings 25 are situated on the periphery of the opening 24 and are diametrically opposed.

The electric motor 20 is immobilized against rotating with respect to the intermediate support member 10 by means of a lug 12 extending out of the intermediate support member 10 and collaborating with a cutout 22 of the electric motor 20. The intermediate support member 10 has a shape that complements that of the outer casing of the electric motor 20 at the front face 20a thereof, for example in this instance the form of two half-shells formed as an integral part of the intermediate support member 10.

The toothed wheel 61 of the geared power transmission system 60 is mounted with the ability to rotate on a shaft 31 which is mounted mainly in the intermediate support member 10, but also in the housing 30. For this purpose, the intermediate support member 10 comprises a means of attachment of the shaft 31, in the form of a barrel 14, and the housing 30 also comprises a means for guiding the shaft 31, in the form of a barrel 35. The shaft 31 is mounted as a tight or interference fit in the barrel 14 of the intermediate support member, and the shaft 31 is mounted as a sliding fit in the barrel 35 of the housing. The toothed wheel 61 is a two-stage wheel, the first stage 62 of the toothed wheel 61 meshing with the worm 21 of the output shaft of the electric motor 20 and the second stage 63 of the toothed wheel 61 meshing with the toothed sector 71 of the torque output element 70.

The intermediate support member 10 has a first face 10a, on which the geared power transmission system 60 is mounted, facing the housing 30, and a second face 10b facing the electronic board 50.

FIG. 2 shows more precisely the assembling of the elements in the housing 30. It may thus be seen that the intermediate support member 10 is attached to the housing by means of attachment, notably screws. One region of the intermediate support member 10 partially covers the output shaft of the electric motor, this same region of the intermediate support member 10 including the guide bearing 13 that guides the rotation of the output shaft of the electric motor 20.

Ribs projecting from the guide barrel 14 extend on the second face 10b of the intermediate support member and stiffen the intermediate support member 10.

The cover 40 comprises an electrical connector for connecting the actuator to an electric power source of the vehicle. The electronic board 50 lies between the intermediate support member 10 and the cover 40. The electronic board 50 is attached to the cover by means of attachment, notably clips. The electronic board is connected both to the electrical connector and to the electric motor 20 via conducting pins.

FIG. 3 shows more precisely the arrangement of the geared power transmission system 60 collaborating with the toothed sector 71 of the torque output element 70. During operation, the worm 21 of the shaft of the electric motor 20 meshes with the toothed wheel 61 via the first stage 62 thereof, and then the torque is transmitted to the toothed sector 71 of the torque output element 70 via the second stage 63 of the toothed wheel 61.

FIG. 4 shows how the angular position of the torque output element 70 is recovered. The torque output element 70 has, at the opposite end from the connector 73, a magnetic target 72 that faces a sensor 51 mounted on the electronic board 50. The magnetic target 72 is adhesively bonded, clip-fastened or screwed to the torque output element. The torque output element 72 passes right through the intermediate support member 10 from the first face 10a to the second face 10b of the intermediate support member, via an opening 15. The intermediate support member 10 does not contribute to guiding the rotation of the torque output element 72; there is a radial clearance between the intermediate support member 10 and the torque output element 72.

Although the invention has been described in connection with a particular embodiment, it is quite clear that it is by no means limited thereto and that it includes all the technical equivalents of the means described.

In the claims, the reference symbols between parentheses should not be interpreted as limiting the claim.

1. An actuator for a parking lock system of a vehicle transmission gearbox, said actuator comprising an intermediate support member to which an electric motor and a geared power transmission system kinematically connected to the electric motor are attached, said actuator further comprising a torque output element that meshes with the geared power transmission system and is movable in rotation between a locking position and an unlocking position, characterized in that the intermediate support member and the torque output element are housed in a housing and the torque output element is guided in rotation by the housing.

2. The actuator as claimed in claim 1, wherein the geared power transmission system is a worm and wheel system, said worm being on an output shaft of the electric motor.

3. The actuator as claimed in claim 2, wherein the end of the output shaft of the electric motor is guided in rotation by the intermediate support member.

4. The actuator as claimed in claim 1, wherein the electric motor comprises a front face and a rear face, said front face being mounted in an opening of the intermediate support member and the rear face being held on the intermediate support member by a compression plate attached to the intermediate support member.

5. The actuator as claimed in claim 1, wherein the electric motor is immobilized against rotating with respect to the intermediate support member by means of a lug extending out of the intermediate support member and collaborating with a cutout of the electric motor.

6. The actuator as claimed in claim 2, wherein the toothed wheel is mounted with the ability to rotate on a shaft, said shaft being mounted on the one hand in the intermediate support member and, on the other hand, in the housing.

7. The actuator as claimed in claim 1, wherein the torque output element comprises a toothed sector that meshes with the geared power transmission system.

8. The actuator as claimed in claim 7, wherein the toothed wheel system is a two-stage system, the first stage of the toothed wheel meshing with the worm of the output shaft of the electric motor and the second stage of the toothed wheel meshing with the toothed sector of the torque output element.

9. The actuator as claimed in claim 1, wherein the intermediate support member has a first face, on which the geared power transmission system is mounted, facing the housing, and a second face facing an electronic board.

10. The actuator as claimed in claim 9, wherein said torque output element passes through the intermediate support member and, at its opposite end from the torque output, has a magnetic target facing a sensor mounted on the electronic board.

11. The actuator as claimed in claim 2, wherein the electric motor comprises a front face and a rear face, said front face being mounted in an opening of the intermediate support member and the rear face being held on the intermediate support member by a compression plate attached to the intermediate support member.

12. The actuator as claimed in claim 2, wherein the electric motor is immobilized against rotating with respect to the intermediate support member by means of a lug extending out of the intermediate support member and collaborating with a cutout of the electric motor.

13. The actuator as claimed in claim 3, wherein the toothed wheel is mounted with the ability to rotate on a shaft, said shaft being mounted on the one hand in the intermediate support member and, on the other hand, in the housing.

14. The actuator as claimed in claim 2, wherein the torque output element comprises a toothed sector that meshes with the geared power transmission system.

15. The actuator as claimed in claim 2, wherein the intermediate support member has a first face, on which the geared power transmission system is mounted, facing the housing, and a second face facing an electronic board.

16. The actuator as claimed in claim 3, wherein the electric motor comprises a front face and a rear face, said front face being mounted in an opening of the intermediate support member and the rear face being held on the intermediate support member by a compression plate attached to the intermediate support member.

17. The actuator as claimed in claim 3, wherein the electric motor is immobilized against rotating with respect to the intermediate support member by means of a lug extending out of the intermediate support member and collaborating with a cutout of the electric motor.

18. The actuator as claimed in claim 4, wherein the toothed wheel is mounted with the ability to rotate on a shaft, said shaft being mounted on the one hand in the intermediate support member and, on the other hand, in the housing.

19. The actuator as claimed in claim 3, wherein the torque output element comprises a toothed sector that meshes with the geared power transmission system.

20. The actuator as claimed in claim 3, wherein the intermediate support member has a first face, on which the geared power transmission system is mounted, facing the housing, and a second face facing an electronic board.
